(19) United States
(12) Patent Application Publication
(10) Pub. No.: US 2015/0309395 A1
(43) Pub. Date: Oct. 29, 2015

(54) PHOTOGRAPHIC DEVICE MOUNTS

(71) Applicant: James A. Tomasewski, Bay Village, OH (US)

(72) Inventor: James A. Tomasewski, Bay Village, OH (US)

(21) Appl. No.: 14/695,158

(22) Filed: Apr. 24, 2015

Related U.S. Application Data
(60) Provisional application No. 61/984,473, filed on Apr. 25, 2014.

(51) Int. Cl. G03B 17/56; H04M 1/04; F16B 2/08; F16B 1/00; F16M 13/02

(52) U.S. Cl. CPC G03B 17/561; F16B 1/00; F16M 13/022; F16B 2/08; H04M 1/04; F16B 2001/0035

(57) ABSTRACT

A mount for photographic devices including smart phones, tablets, digital cameras has a mount frame and pivoting mount arm, powerful magnets on the mount frame for attachment of the mount to ferrous surfaces or structures, and an attachment device on the mount arm configured for attachment to a photographic device. The mount frame may be otherwise mechanically attached to any support structure, and a photographic device may be in a position or orientation relative to the mount arm. Compressible friction pads are provided on surfaces of the mount frame and mount arm.

### RELATED APPLICATIONS

This application is related to U.S. provisional application No. 61/984,473 filed Apr. 24, 2014.

### FIELD OF THE INVENTION

The present disclosure and related inventions are in the general field of mounting devices and more particularly devices for mounting or holding photographic devices.

### BACKGROUND

Digital technology has transformed many things, including photography. And the trend has been towards smaller and lighter photographic devices. Although photographic devices still exist in the form of traditional cameras including film and digital cameras of all sizes, photographic and video imaging devices are now incorporated into many different kinds of digital devices such as smart phones and tablets.

But many traditional photographic accessories have not been transformed to better suit modern photographic devices and the uses thereof in contemporary lifestyles. Conventional camera tripods for the most part remain comparatively large and cumbersome. But while use of a tripod provides the best quality support and resulting image from a photographic device, and allows an individual to take self portraits (“selfies”) or video at more than arm's length, most photographers seldom carry a tripod due to the inconvenience.

There is a need for a photographic device support system better suited for modern technology and a contemporary lifestyle which includes near constant use of digital devices.

### SUMMARY OF THE DISCLOSURE

The present disclosure and related inventions provides photographic device mounts which are adapted and configured for use with a wide variety of digital devices including smart phones and tablets, and which are very compact and highly adaptable to a wide range of use configurations.

In accordance with one aspect of the present disclosure and related inventions, a device mount includes a mount frame with a generally planar base and first and second parallel and spaced apart side walls which extend from the base; at least one magnet attached to the generally planar base of the mount frame; a mount arm attached to the mount frame, the mount arm having a generally planar section which fits between the first and second side walls of the mount base and a first end and a second end; a pivot located proximate to the first end of the mount arm and attached to the mount frame for pivotal movement of the mount arm relative to the mount frame, and an attachment device located proximate to the second end of the mount arm, the attachment device configured for attachment to a device.

These and other aspects and features of the disclosure and related inventions are further described herein with reference to the accompanying Figures.

### DESCRIPTION OF THE FIGURES

In the accompanying Figures:

FIG. 1 is a perspective view of a representative embodiment of a photographic device mount of the present disclosure in combination with a photographic device in the form of a smart phone;

FIG. 2 is an alternate perspective view of the photographic device mount of FIG. 1;

FIG. 3 is a perspective view of the photographic device mount of FIGS. 1 and 2 shown in a folded or stowed configuration;

FIG. 4 is a perspective view of the photographic device mount of FIGS. 1-3 in an opened configuration prior to attachment to a photographic device such as a smart phone, and with stored contents in the form of a fastening cord removed from the photographic device mount;

FIG. 5 is an elevation of a photographic device mount of the present disclosure in combination with a photographic device in the form of a smart phone and attached to a support structure;

FIG. 6 is a cross-sectional view of an area of attachment of the photographic device mount to a smart phone;

FIG. 7 is a perspective view of a photographic device mount of the present disclosure in combination with a fastening cord in a representative use configuration;

FIG. 8 is a perspective view of a photographic device mount of the present disclosure in an alternate use configuration;

FIG. 9 is a perspective view of a first embodiment of an attachment adapter of the photographic device mount of the present disclosure;

FIG. 10 is a perspective view of a second embodiment of an attachment adapter of the photographic device mount of the present disclosure, and

FIG. 11 is a perspective view of a third embodiment of an attachment adapter of the photographic device mount of the present disclosure.

### DETAILED DESCRIPTION

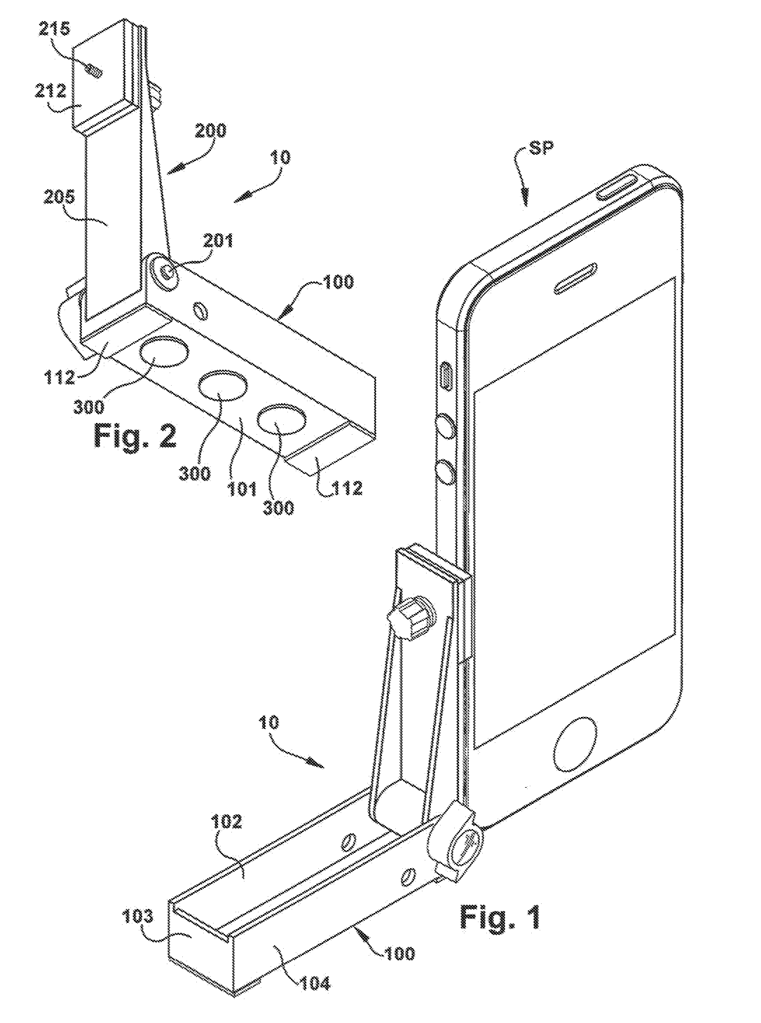

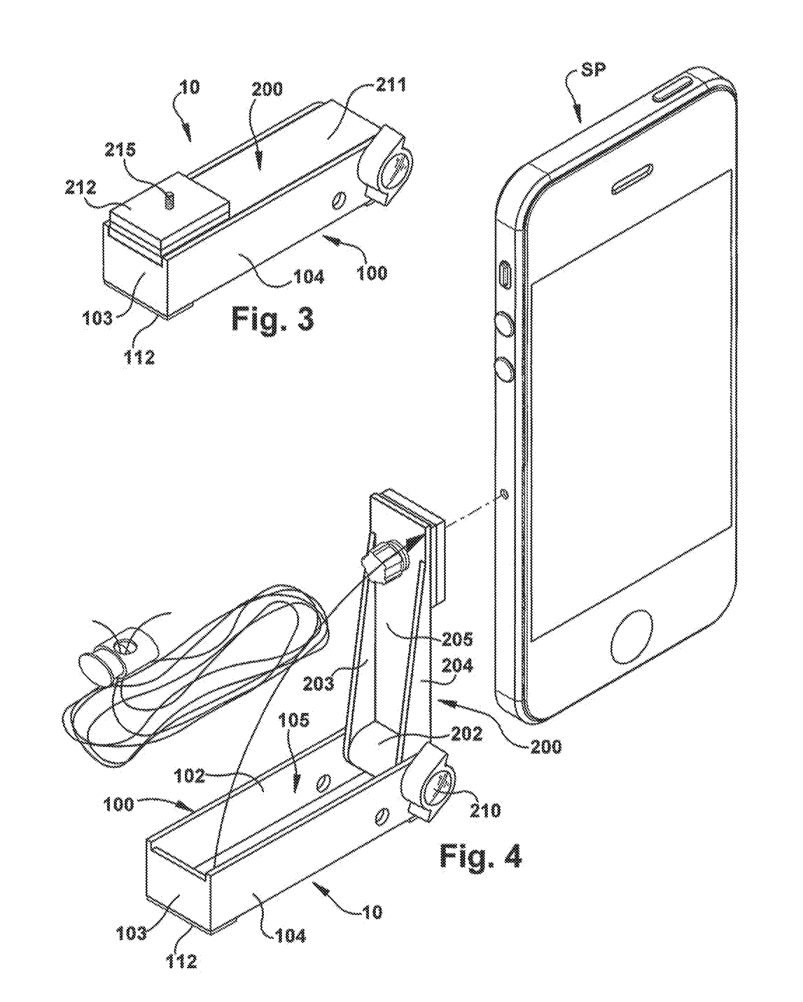

As illustrated in FIGS. 1-4, a representative embodiment of a photographic device mount (or “mount” or “CVT mount”), indicated generally at 10, is shown in various configurations and in combination with a photographic device such as a smart phone SP, such as for example an Apple iPhone° or Samsung Galaxy® phone or the like. Other photographic devices which the mount 10 can be used in connection with include but are not limited to digital cameras and video cameras of any form or type, tablets such as the Apple iPad® or Samsung Android® tablet, or any other type of imaging or electronic device.

The mount 10 includes a main frame 100 which as illustrated may be in the general form of box frame with a base 101 and intersecting walls 102, 103 and 104 which extend from the base 101 to form a compartment 105 within the main frame 100. The main frame 100 provides a strong structural base for the mount 10 and the compartment 105 provides for storage and a compact collapsible configuration for the mount 10 as further described.

Attached to the main frame 100 is a device mount arm 200 which as shown extends from between longitudinal parallel walls 102 and 104 and is secured thereto by a pin 201 (FIG. 2) which extends through walls 102 and 104 and through an end 202 of the mount arm 200 whereby the mount arm 200 is pivotable about pin 201 relative to the main frame 100. For example, in FIGS. 1, 2 and 4, the mount arm 200 is shown in a ninety-degree orientation relative to the base 101 of the main frame 100, and in FIG. 3 collapsed together with and generally parallel with the main frame 100. In the illustrated embodiment, the mount arm 200 has a generally planar section 205 and opposed supports 203 and 204 which extend from end 202 to provide structural strength. A width dimension of the planar section 205 and supports 203, 204 fits within the compartment 105 such that the mount arm 200 folds or collapses substantially within or closely proximate to the main frame 100 and the compartment 105 of the main frame 100. A fastener 210, such as a threaded fastener, is provided on one end of pin 201 which is operative to apply axial pressure along pin 201 and thereby compress the mount arm end 202 between main frame walls 102, 104, to either lock the mount arm 202 in any desired position relative to the main frame 100 or apply sufficient pressure to hold the mount arm 200 in a desired position by friction.

As shown in FIGS. 2 and 3, the mount arm 200 has an upper planar surface 211 generally opposed to the main frame 100 which provides a primary mounting or mating surface for combination with a photographic device. Any type of mounting mechanism may be attached to or extend through the planar section 205, such as for example one or more pads 212 which may be made of plastic or elastomeric or foam or foam-like material such as Neoprene™ or the like and which may also optionally be combined with adhesive or tack agent. A device attachment or fastener 215, for example in the form of a threaded shaft, is attached to or extends through the planar section 205 and may be co-located with the one or more pads 212 as illustrated. The fastener 215 is configured for engagement or direct engagement with a photographic device, as further described.

As shown in FIG. 2, one or more magnets 300 are incorporated into or otherwise attached to the base 101 and may be exposed through the base opposite to the compartment 105. The magnets are preferable strong permanent magnets such as rare earth magnets, and may be in any suitable shape, such as for example cylindrical with a diameter of 5-15 mm. It has been observed by the inventor that the use of at least two and even three rare earth magnets of this general size and in the locations as illustrated on the main frame 100 do not interfere with the function or memory of digital photographic devices such as camera-equipped smart phones or digital cameras. The magnets 300 may preferably fit into recesses formed in the exterior side of the base 101, opposite compartment 105. The magnets 300 are spaced from any photographic device which is attached to the mount arm 200 so that there is no disturbance of the device by the magnetic field.

Also secured to an exterior surface of the base 101 are one or more pads 112 which may be made of plastic or elastomeric or foam or foam-like material such as Neoprene™ or the like and which may also optionally be combined with adhesive or tack agent. The pads 112 preferably provide high friction with a wide variety of surfaces or coatings, project beyond the exposed surfaces of the magnets 300, and are slightly compressible by the force of the magnets 300 such that the pads 112 are compressed between the mount base 101 and a ferrous structure to which the mount base 101 is magnetically attached, or compressed by other means of attachment of the mount base 101 to a non-ferrous structure as described.

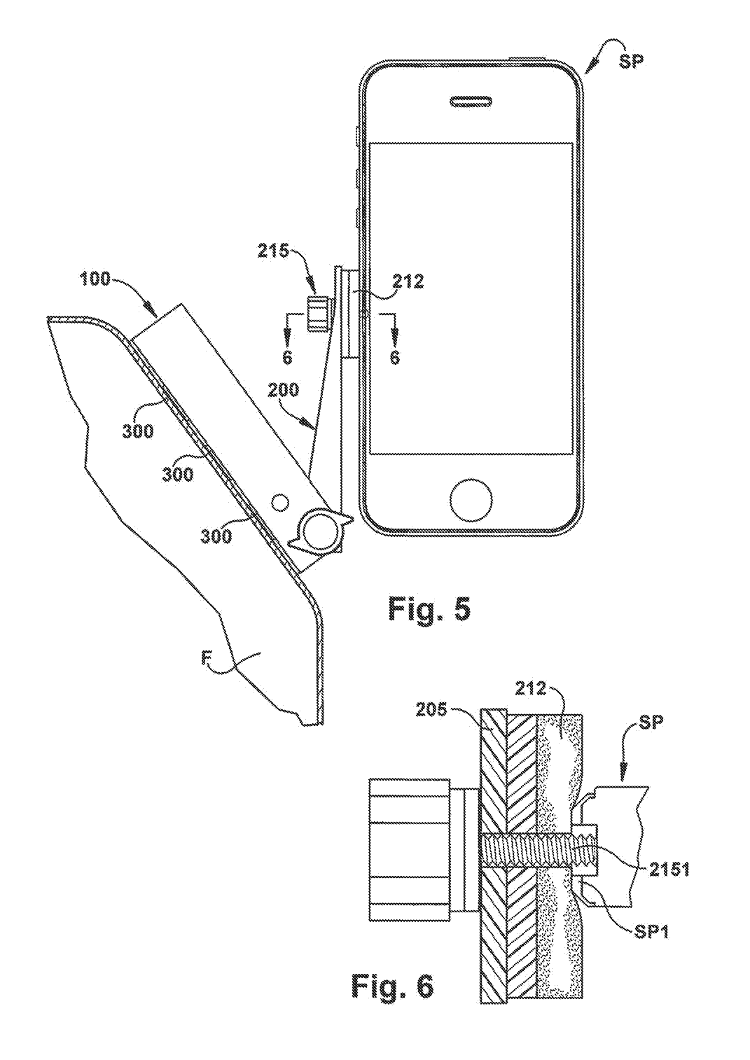

As further illustrated in FIGS. 5, 6 and 9, the mount 10 is attached to a photographic device such as a smart phone SP in one embodiment by securement of the device attachment 215 directly to the photographic device SP, such as for example by threaded engagement of the threaded shaft 2151 of the device attachment 215 into a threaded bore SP1 which is provided at the perimeter SPP of the photographic device SP, as shown in FIG. 6. The threaded bore SP1 may be in any location on an exterior surface or perimeter of any photographic device, such as for example at any location in or through the side or perimeter wall of a smart phone as illustrated, in or through any other exterior surface, or in any other attachment or mount which is otherwise secured to or part of a photographic device.

FIGS. 9, 10 and 11 illustrate alternate embodiments of device attachments. The device attachment 215 illustrated in FIG. 9 further includes a bushing 2152 in a generally cylindrical configuration which a height which extends from the pad 212 and through which the threaded shaft 2151 extends. The bushing 2152 is advantageous for attachment to the exterior of certain photographic devices with more complex exterior configurations. FIG. 10 illustrates an alternate embodiment of a bushing 2153 which is also generally cylindrical with an extended length which is adaptable for use with other types of photographic devices. And FIG. 11 illustrates an alternate embodiment of a bushing 2154 which fits with an alternate threaded shaft 2155 of a different, e.g. larger thread size.

The device attachment 215 may include the threaded shaft 2151 which extends from a knob 216 and through a distal end of the mount arm 200 and pad 212. An additional pad mount 213 may be provided between the mount arm 200 and pad 212. By engagement of the threaded shaft 2151 with the bore SP1, the photographic device SP is drawn tightly against the pad 212 and mount arm 200 to securely attach the mount 10 to the device SP. The clamp pressure and frictional contact of the pad 212 with the device SP results in a very firm and secure mounting of the device SP with the mount 10, with the mount 10 in any particular configuration or orientation as illustrated, and with the device SP in any orientation relative to the mount arm 200.

FIG. 5 illustrates the mount 10 with the base 101 magnetically attached to a ferrous structure F by magnets 300, and with the mount arm 200 in a generally vertical orientation. The device SP is illustrated also in a generally vertical orientation, but could be in any orientation about the axis of the attachment 215 as described.

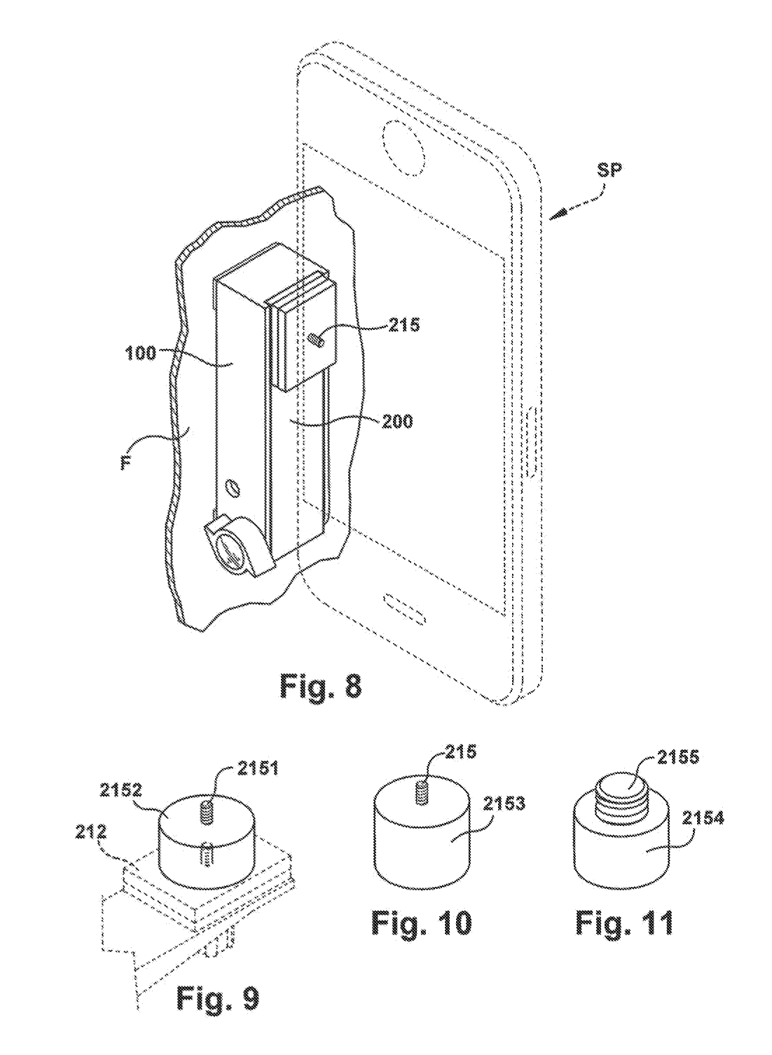

FIG. 8 illustrates the mount 10 with the base 101 magnetically attached to a generally vertical surface of a ferrous structure F by the magnets 300 (not shown), and with the mount arm 200 in the folded or collapsed position with the base 101 to provide a generally vertically oriented mount for the device SP as shown in phantom, representing a device of any type such as smart phone, tablet or camera of any size or configuration. The device SP may be of any size, such as for example smart phones and tablets of various sizes and with various dimensions.

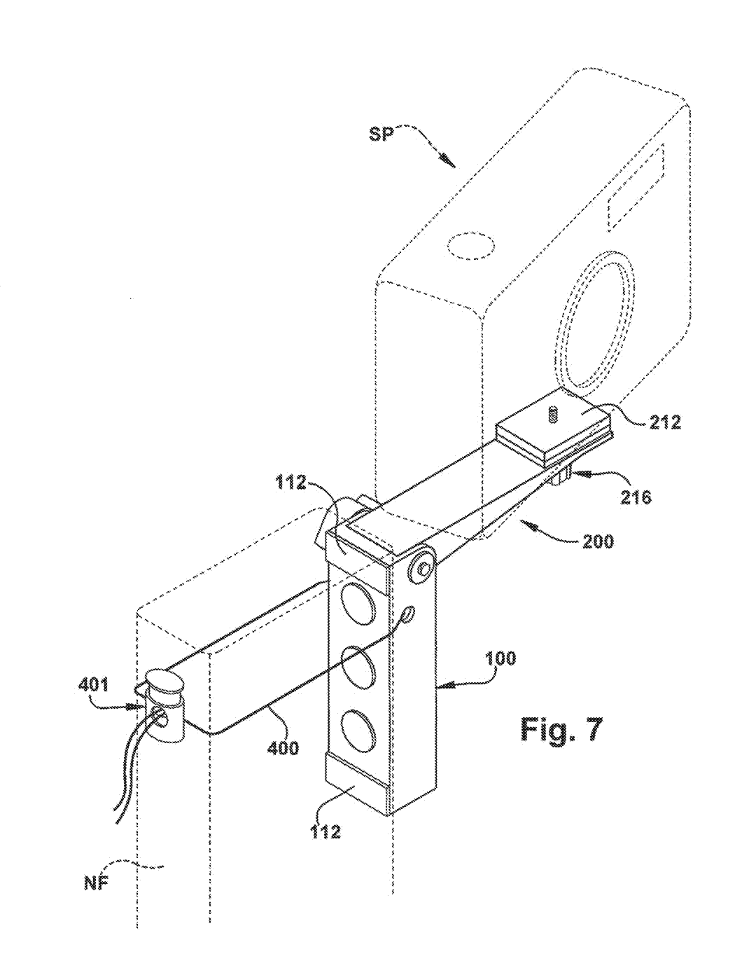

FIG. 7 illustrates the mount 10 in an alternate configuration and orientation, with the mount base 100 in a generally vertical orientation and secured to a non-ferrous structure NF, for example by a cord or strap 400 which extends from the mount base 101 around the structure NF and is tightened by a conventional fastening device 401. Although the magnets 300 are not relied upon in this type of set-up, the pads 112 provide the primary contact surfaces with the structure NF. The mount arm 200 can be positioned in any orientation as described, such as the illustrated ninety degree position to provide a generally horizontal support for the device SP or other photographic device, which may be in any radial position about the device attachment 215. Also shown in FIG. 7 is the use of an adapter such as bushing 2154 which fits with the device attachment 215 and a threaded bore in the photographic device such as a camera.

The mount as disclosed and described may be manufactured in any size or scale and is particularly well suited for use with smart phones and tables such as the Apple iPhone and Samsung Galaxy and other types of smart phones. Representative nominal dimensions or approximate size ranges for the described embodiments are 2.25 to 3.50 inches in overall length of the mount frame and mount arm, 0.50 to 1.25 inches in height or width of the mount frame with the described generally rectangular cross-sectional configuration of the mount frame and generally rectangular configuration of the mount arm. Other sizes and dimensions are possible and within the scope of the present disclosure. In general, a longer nominal length dimension of the mount frame and/or mount arm is preferable for use in connection with larger devices such as larger smart phones and tablets or larger cameras and video cameras.

The disclosure and related inventions thus provide novel, utilitarian and highly configurable and compact device mounts for a wide variety of digital devices for photography, videography or other operations.

What is claimed is:

1. A mount comprising:
a mount frame having a generally planar base and first and second parallel and spaced apart side walls which extend from the base;
at least one magnet attached to the generally planar base of the mount frame;
a mount arm attached to the mount frame, the mount arm having a generally planar section which fits between the first and second side walls of the mount base and a first end and a second end;
a pivot located proximate to the first end of the mount arm and attached to the mount frame for pivotal movement of the mount arm relative to the mount frame;
an attachment device located proximate to the second end of the mount arm, the attachment device configured for attachment to a device.

2. The mount of claim 1 further comprising at least one pad attached to the generally planar base of the mount frame proximate to the at least one magnet.

3. The mount of claim 1 further comprising at least one pad attached to the mount arm proximate to the second end of the mount arm.

4. The mount of claim 1 wherein the attachment device is a threaded shaft.

5. The mount of claim 1 wherein the attachment device is rotatable within the mount arm.

6. The mount of claim 1 wherein the mount frame has a compartment and the mount arm is configured to fit substantially entirely within the compartment.

7. The mount of claim 2 wherein the at least one pad attached to the generally planar base of the mount frame projects from a surface of the base of the mount frame beyond an exposed surface of the at least one magnet.

8. The mount of claim 1 further comprising a fastening device operative to hold a position of the pivot proximate to the first end of the mount arm and attached to the mount frame.

9. The mount of claim 1 in combination with a smart phone, the smart phone having a threaded boss configured for threaded engagement with the attachment device of the mount.

10. The mount of claim 1 in combination with a tablet, the tablet having a threaded boss configured for threaded engagement with the attachment device of the mount.

11. The mount of claim 1 in combination with a threaded adapter in threaded engagement with the attachment device.

12. The mount of claim 1 in combination with a flexible securing device which extends from the mount frame for attachment to a structure for support of the mount.

13. The mount of claim 1 wherein the mount frame is generally rectangular and the mount arm has a length dimension which is approximately equal to a length dimension of the mount frame.

14. The mount of claim 1 wherein the generally planar section of the mount arm fits between the first and second side walls of the mount base and is spaced from the generally planar base of the mount frame when in a folded configuration whereby the mount frame and mount arm form a substantially closed compartment when the mount arm is in a folded configuration.

15. A mount for a photographic device, the mount comprising:
a generally cubic mount frame having a generally planar base, first and second parallel and spaced apart side walls which extend from a common side of the planar base, and an end wall which extends from the common side of the planar base and intersects with the side walls; and a pivot end between the side walls and generally opposite the end wall;
a mount arm pivotally mounted to the mount base, the mount arm having a first end located proximate to the pivot end of the mount frame, a pivot engaged with the first end of the mount arm and the pivot end of the mount frame, the mount arm being pivotable about the pivot to extend from the mount frame or to a position generally parallel to the mount frame, the mount arm having an attachment end generally distal from the pivot, and an attachment device on the mount arm configured for attachment to a photographic device;
the mount frame configured for connection to a support structure to support the mount and a photographic device attached to the mount.

16. The mount of claim 15 further comprising at least one magnet on the planar base of the mount frame.

17. The mount of claim 15 further comprising a fastener in connection with the pivot and operative to secure the mount arm in a position relative to the mount frame.

18. The mount of claim 15 further comprising a securement device in combination with the mount frame and configured to extend from the mount frame to a structure to support the mount.

19. The mount of claim 15 further comprising a pad attached to the mount frame.

20. The mount of claim 15 further comprising a pad attached to the mount arm.

21. The mount of claim 15 wherein the attachment device is proximate to the attachment end of the mount arm.

22. The mount arm of claim 15 wherein the attachment device of the mount arm is in the form of a threaded shaft.

23. The mount arm of claim 15 in combination with a photographic device attached to the mount arm.

24. The mount of claim 23 wherein the photographic device has a threaded bore, and the attachment device of the mount arm is engaged with the threaded bore.

25. The mount of claim 24 wherein the threaded bore of the photographic device is located on a perimeter of the photographic device, and the mount arm is attached by the attachment device to the perimeter of the photographic device.

26. The mount of claim 15 in combination with a smart phone.

27. The mount of claim 15 in combination with a tablet.
